(19) United States
(12) Patent Application Publication
(10) Pub. No.: US 2012/0195199 A1
(43) Pub. Date: Aug. 2, 2012

(54) WIRELESS TERMINAL, AND WIRELESS COMMUNICATION METHOD

(75) Inventors: Takafumi Koga, Daito-shi (JP); Yoshizo Sato, Daito-shi (JP)

(73) Assignee: KYOCERA CORPORATION, Kyoto-shi, Kyoto (JP)

(21) Appl. No.: 13/497,389

(22) PCT Filed: Sep. 17, 2010
(86) PCT No.: PCT/JP2010/066208

§ 371 Date: Mar. 21, 2012

(30) Foreign Application Priority Data
Sep. 28, 2009 (JP) 2009-223059

(51) Int. Cl. H04W 28/10

(52) U.S. Cl. 370/235

(57) ABSTRACT

A QoS management unit receives notification of QoS parameters for a plurality of uplink service flows from a wireless base station. A burst region management unit receives notification of an uplink user data burst region from the wireless base station. A service flow assignment unit assigns a region of uplink service flows at the uplink user data burst region assigned to its own terminal. The service flow assignment unit assigns a region of uplink service flows, prioritizing the region of at least one service flow satisfying conditions for the transmission rate, delay time, and delay time variation of the notified QoS parameters for each service flow over a region of another service flow.

### TECHNICAL FIELD

The present invention relates to a wireless terminal and a wireless communication method, particularly a wireless terminal and wireless communication method transmitting data of a plurality of service flows to a wireless base station using an OFDM or OFDMA (Orthogonal Frequency Division Multiple Access) frame.

### BACKGROUND ART

In various wireless communication systems such as the WiMAX (Worldwide Interoperability for Microwave Access), there is the case where data of a plurality of service flows is transmitted from a wireless terminal to a wireless base station. For example, there is the case where data of a VoIP (Voice over Internet Protocol) service flow and data of an FTP (File Transfer Protocol) service flow are transmitted at the same time from a wireless terminal to a wireless base station.

A service flow is characterized by the QoS (Quality of Service) representing the service quality determined by a wireless base station or management server (for example, refer to PTL 1 (Japanese Patent Laying-Open No. 2007-166593)). The QoS defines parameters such as the maximum transmission rate, minimum transmission rate, and maximum permitted time. A wireless terminal schedules the service flow data for transmission to a wireless base station so as to satisfy the conditions of the QoS parameters defined,

### CITATION LIST

### Patent Literature

PTL 1: Japanese Patent Laying-Open No. 2007-166593

### SUMMARY OF INVENTION

### Technical Problem

However, there may be inconvenience by just scheduling the service flow data so as to satisfy the conditions of the QoS parameters defined.

For example, in the case where a user wishes to transfer a file as swiftly as possible in a television conference, prevailing over the video stream, the file transfer may be time-consuming with the transfer by FTP not given priority.

In view of the foregoing, an object of the present invention is to provide a wireless terminal and a wireless communication method that can swiftly transfer data of a service flow desired to be transmitted rapidly by a user, or that requires rapid transfer due to its nature.

### Solution to Problem

To solve the problems set forth above, the present invention includes a QoS management unit receiving notification of QoS parameters for a plurality of uplink service flows from a wireless base station, a burst region management unit receiving notification of an uplink user data burst region from the wireless base station, and a service flow assignment unit 10 assigning a region of the plurality of uplink service flows at an uplink user data burst region assigned to its own terminal. Service flow assignment unit 10 assigns the region of the uplink service flows, prioritizing a region of at least one service flow satisfying conditions of a transmission rate, delay time, and delay time variation in the notified QoS parameters for each uplink service flow over the region of another service flow.

Preferably, service flow assignment unit 10 assigns a region of a service flow specified by a user, giving priority over the region of another service flow.

Preferably, service flow assignment unit 10 assigns the region of a predetermined service flow, giving priority over the region of another service flow.

Preferably, the predetermined service flow is FTP.

The present invention includes the steps of receiving notification of QoS parameters for a plurality of uplink service flows from a wireless base station, receiving notification of an uplink user data burst region from the wireless base station, and assigning a region of uplink service flows at the uplink user data burst region assigned to its own terminal. The assigning step includes the step of assigning the region of uplink service flows, prioritizing the region of at least one service flow satisfying conditions of a transmission rate, delay time, and delay time variation in the of notified QoS parameters of each uplink service flow over the region of another service flow.

### Advantageous Effects of Invention

According to the present invention, data of a service flow desired to be transmitted rapidly by a user, or that requires rapid transfer due to its nature can be transmitted rapidly.

### BRIEF DESCRIPTION OF DRAWINGS

FIG. 1 represents a configuration of a wireless communication system according to an embodiment of the present invention,

FIG. 2 represents a configuration of a wireless terminal according to an embodiment of the present invention.

FIG. 3 represents an example of a service type, an application belonging to the service type, and QoS parameters defined for the service type.

FIG. 4 represents a sequence for transmitting and receiving data of a service flow at a wireless communication system according to an embodiment of the present invention.

FIG. 5 is a flowchart representing an assignment procedure of a burst region of a service flow by a wireless terminal according to a first embodiment of the present invention.

FIG. 6 is a flowchart representing an assignment procedure of a burst region of a service flow by a wireless terminal according to a second embodiment of the present invention.

FIG. 7 is a flowchart representing an assignment procedure of a burst region of a service flow by a wireless terminal according to a third embodiment of the present invention.

FIG. 8 is a flowchart representing an assignment procedure of a burst region of a service flow by a wireless terminal according to a fourth embodiment of the present invention.

### DESCRIPTION OF EMBODIMENTS

Embodiments of the present invention will be described hereinafter with reference to the drawings.

Although the embodiments of the present invention will be described based on an example of a WIMAX system according to OFDMA, the present invention is also applicable to other communication systems.

### First Embodiment

(Configuration of Wireless Communication System)

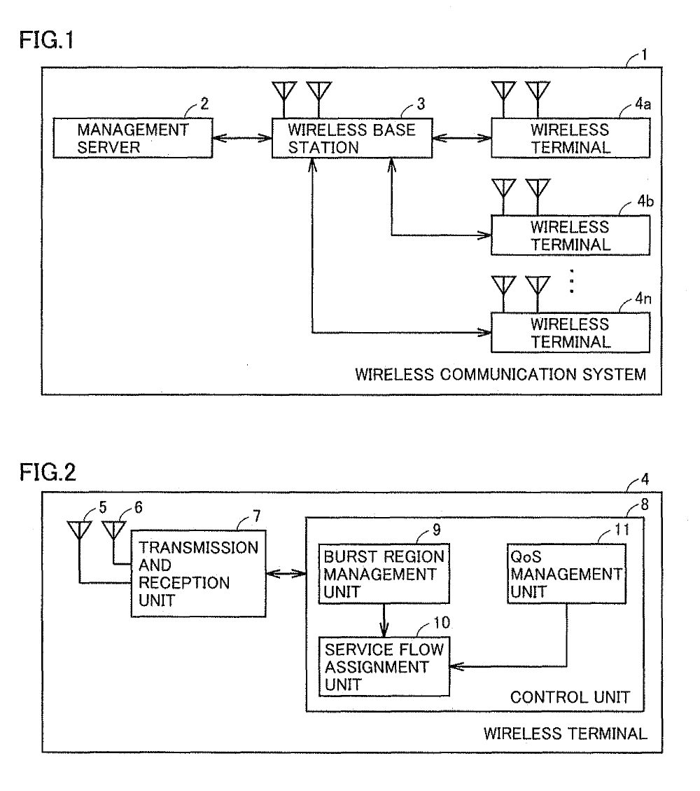

FIG. 1 represents a configuration of a wireless communication system according to an embodiment of the present invention.

Referring to FIG. 1, a wireless communication system 1 includes a wireless base station 3, and a plurality of wireless terminals 4a-4n communicating with wireless base station 3 in a wireless manner. Wireless communication system 1 further includes a management server 2 connected to wireless base station 3 through a wired communication line. Management server 2 executes the processing of authentication, permission, billing, and the like for wireless terminals 4a-4n.

In the description set forth below, wireless terminals 4a-4n may be generically referred to as “wireless terminal 4”.

(Configuration of Wireless Terminal)

FIG. 2 represents a configuration of a wireless terminal according to an embodiment of the present invention.

Referring to FIG. 2, wireless terminal 4 includes antennas 5 and 6, a transmission and reception unit 7, and a control unit 8. Control unit 8 includes a burst region management unit 9, a QoS management unit 11, and a service flow assignment unit 10.

Antennas 5 and 6 receive and transmit a wireless signal from and to a wireless base station 3.

Transmission and reception unit 7 applies a reception process on a signal from wireless base station 3 output from antennas 5 and 6, and a transmission process on a signal towards wireless base station 3 output through antennas 5 and 6. Transmission and reception unit 7 includes, for example, a coding circuit, a modulation circuit, a decoding circuit, a demodulation circuit, an MIMO (Multi In Multi Output) signal processing unit, and the like.

Burst region management unit 9 receives from wireless base station 3 notification of the uplink user data burst region. The uplink user data of this wireless terminal 4 is arranged in the uplink user data burst region.

QoS management unit 11 receives the QoS parameter of a plurality of service flows of the MAC (Media Access Control) layer.

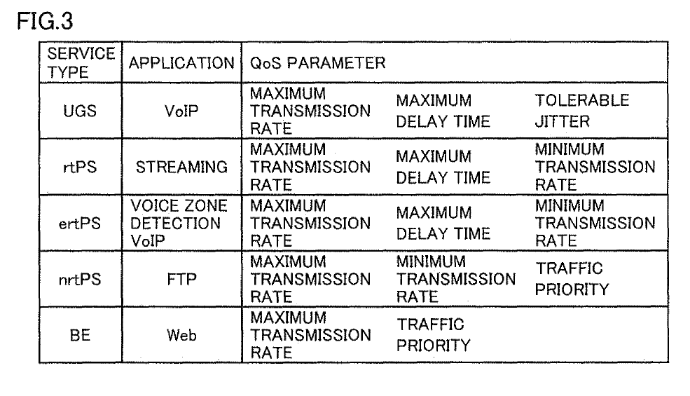

FIG. 3 represents an example of a service type, an application belonging to the service type, and QoS parameters defined for the service type.

Referring to FIG. 3, an application of real time traffic generating a data packet of a variable size at a constant cycle such as VoIP belongs to UGS (Unsolicited Grant Services). The major QoS parameters of UGS include the maximum transmission rate, maximum delay time, and tolerable jitter (time variation in delay time).

An application of real time traffic such as MPEG (Moving Picture Experts Group) video streaming belongs to rtPS (Real-Time Polling Services). The major QoS parameters of rtPS include the maximum transmission rate, maximum delay time, and minimum transmission rate.

Voice zone detection VoIP, i.e. VoIP with a silence removal function belongs to ertPS (extended rtPS). The major QoS parameters of ertPS include the maximum transmission rate, maximum delay time, and minimum transmission rate.

An application of non-real time traffic such as FTP belongs to nrtPS (non-real-time polling services). The major QoS parameters of nrtPS include the maximum transmission rate, minimum transmission rate, and traffic priority.

An application for surfing WWW (World Wide Web) belongs to BE (Best Effort service). The major QoS parameters of BE include the maximum transmission rate and traffic priority.

Service flow assignment unit 10 assigns the region of a plurality of service flows at the uplink user data burst region assigned to its own terminal. Service flow assignment unit 10 assigns the region of service flows, prioritizing the region of at least one service flow satisfying the conditions of the transmission rate, delay time, and delay time variation in the QoS parameters of the each uplink service flow over the region of another service flow.

(Data Transmission and Reception Operation of Service Flow)

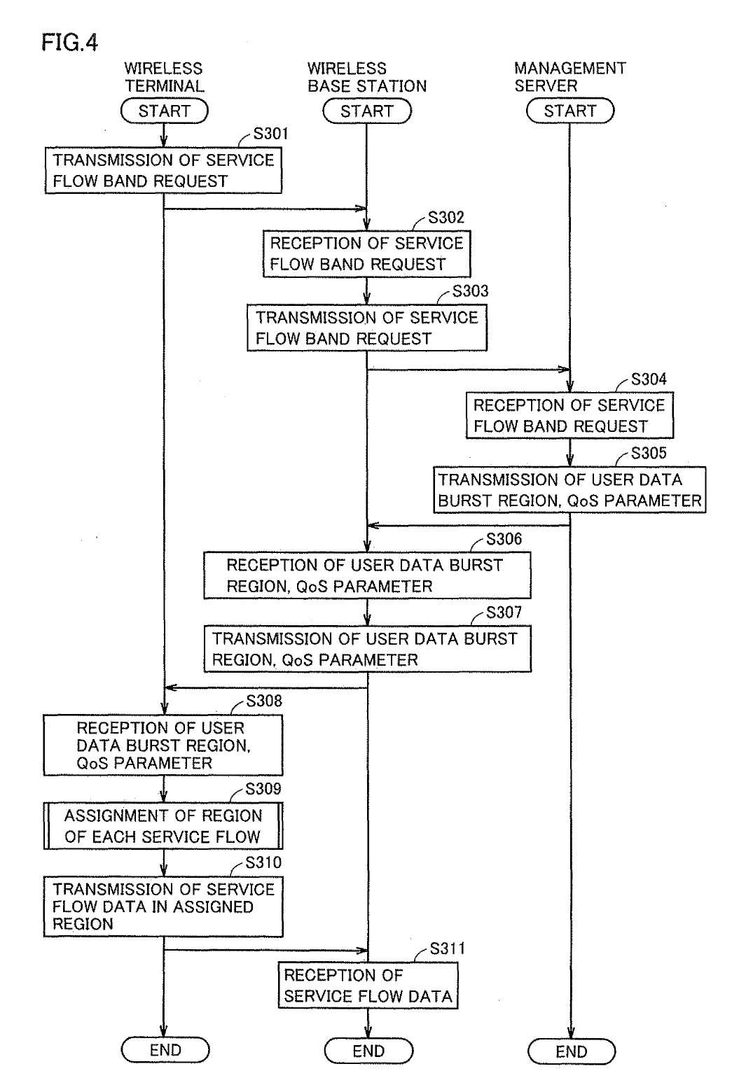

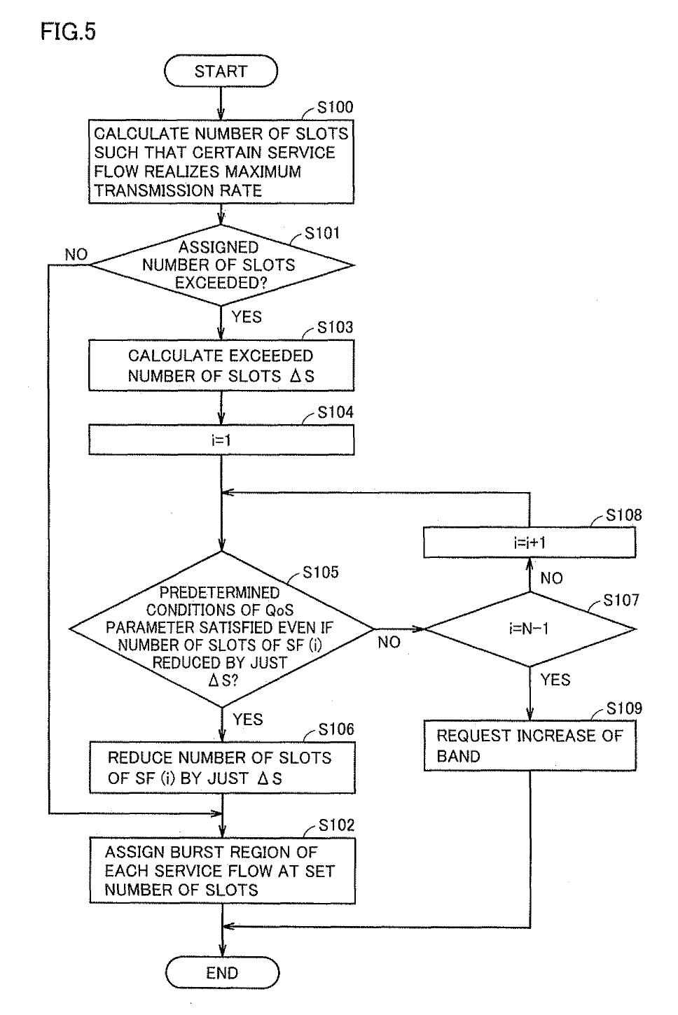

FIG. 4 represents a sequence to transmit and receive data of a service flow at a wireless communication system according to an embodiment of the present invention.

Referring to FIG. 4, service flow assignment unit 10 of wireless terminal 4 transmits a band request for each uplink service flow to wireless base station 3 (step S302).

Wireless base station 3 receives the band request for each uplink service flow transmitted from wireless terminal 4 (step S302), which is further transmitted to management server 2 (step S303).

Management server 2 receives the band request for each uplink service flow from wireless base station 3 (step 5304) to determine the uplink user data burst region of wireless terminal 4 based on the band request, the stored billing information and the like, as well as the QoS parameters of each uplink service flow, and transmits the determined contents to wireless base station 3 (step S305).

Then, wireless base station 3 receives information representing the uplink user data burst region of wireless terminal 4 and the QoS parameters of each uplink service flow transmitted from management server 2 (step S306), and transmits the received information to wireless terminal 4. Wireless base station 3 transmits the QoS parameters of each uplink service flow through a DSA-REQ (Dynamic Service Addition-REQuest) message, for example. Wireless base station 3 transmits information representing the uplink user data burst region of wireless terminal 4 using an UL-MAP (uplink map), for example (S307).

Burst region management unit 9 of wireless terminal 4 receives and manages the information representing the uplink user data burst region transmitted from wireless base station 3. QoS management unit 11 of wireless terminal 4 receives the QoS parameters of each uplink service flow transmitted from wireless base station 3 (step S309).

Service flow assignment unit 10 assigns the region of each uplink service flow at the uplink user data burst region. Service flow assignment unit 10 assigns the region of a service flow, prioritizing at least one service flow satisfying the conditions of the transmission rate, delay time, and delay time variation in the QoS parameters for each uplink service flow over another service flow (step S309).

Transmission and reception unit 7 of wireless terminal 4 arranges the data of the service flow in the assigned region for transmission to wireless base station 3 (step S310).

Wireless base station 3 receives the service flow data in the assigned user data burst region (step S311).

(Assignment Operation of Service Flow)

FIG. 5 is a flowchart representing the assignment procedure of the burst region of a service flow by wireless terminal 4 according to the first embodiment of the present invention. FIG. 5 represents the procedure of altering the burst region of a certain service flow when the burst region of all the service flows is already assigned.

Referring to FIG. 5, service flow assignment unit 10 sets the number of slots of a certain service flow among the generated N service flows such that the certain service flow realizes the maximum transmission rate defined in the QoS parameter. As used herein, a slot is a unit constituted of a plurality of subcarriers on the frequency axis in an OFDMA frame and a plurality of continuous symbols on the time axis. Service flow assignment unit 10 maintains the current value already assigned for the number of slots of the other service flows. The certain service flow may be a predetermined service flow, for example, the FTP service flow. Alternatively, the certain service flow may be a service flow selected by the user of wireless terminal 4 through an input unit (key or touch panel) of wireless terminal 4 (step S100).

Then, service flow assignment unit 10 identifies whether the total number of slots of the N service flows exceeds the number of slots of the user data burst region assigned to its own terminal (step S101).

When the total number of slots of the N service flows is less than or equal to the number of slots of the user data burst region assigned to its own terminal (NO at step S101), service flow assignment unit 10 assigns, for each service flow, a burst region of a size corresponding to the set number of slots, out of the user data burst region assigned to its own terminal (step S102).

In contrast, when the total number of slots of the N service flows exceed the number of slots of the user data burst region assigned to its own terminal (YES at step S101), service flow assignment unit 10 reduces the number of slots to be assigned in the following manner.

Service flow assignment unit 10 calculates the exceeded number of slots, i.e. a value AS that is the total number of slots of the N service flows minus the number of slots of the user data burst region assigned to its own terminal (step S103).

Then, service flow assignment unit 10 assigns an order i (1 to (N−1)) to the remaining (N−1) service flows among the N service flows, excluding the certain service flow to which the maximum transmission rate is assigned. Service flow assignment unit 10 sets order i at 1 (step S104).

Then, service flow assignment unit 10 identifies whether the conditions defined for the maximum transmission rate (for all service types), the minimum transmission rate (for rtPS, ertPS, and nrtPS), the maximum delay time (for UGS, rtPS, and ertPS), and the tolerable jitter (delay time variation) (UGS) among the QoS parameters for service flow SF (i) are satisfied when the number of slots of service flow SF (i) of order i is reduced by just ΔS (step S105).

When the aforementioned conditions defined in the QoS parameters are satisfied (YES at step S105), service flow assignment unit 10 reduces the number of slots of service flow SF (i) by just ΔS (step S106).

Service flow assignment unit 10 assigns for each service flow a burst region of a size corresponding to the set number of slots out of the user data burst region assigned to its own terminal (step S102).

When the conditions defined in the QoS parameters are not satisfied (NO at step S105), and when the order i is not (N−1) (NO at step S107), service flow assignment unit 10 increments order i by just 1 (step S108), and returns to step S105. When the order i is (N−1) (YES at step S107), service flow assignment unit 10 determines that assignment of a service flow that satisfies the conditions defined in the QoS parameters is not possible with the current assigned user data burst region, and requests wireless base station 3 of an increase of the band via transmission and reception unit 7 (step S109).

Thus, according to the first embodiment of the present invention, the data of a service flow selected by a user through an input unit (key or touch panel), or a predetermined service flow can be transmitted at the maximum transmission rate.

### Second Embodiment

The second embodiment relates to a wireless terminal that assigns a burst region for a service flow according to a scheme differing from that of the first embodiment.

(Assignment Operation of Service Flow)

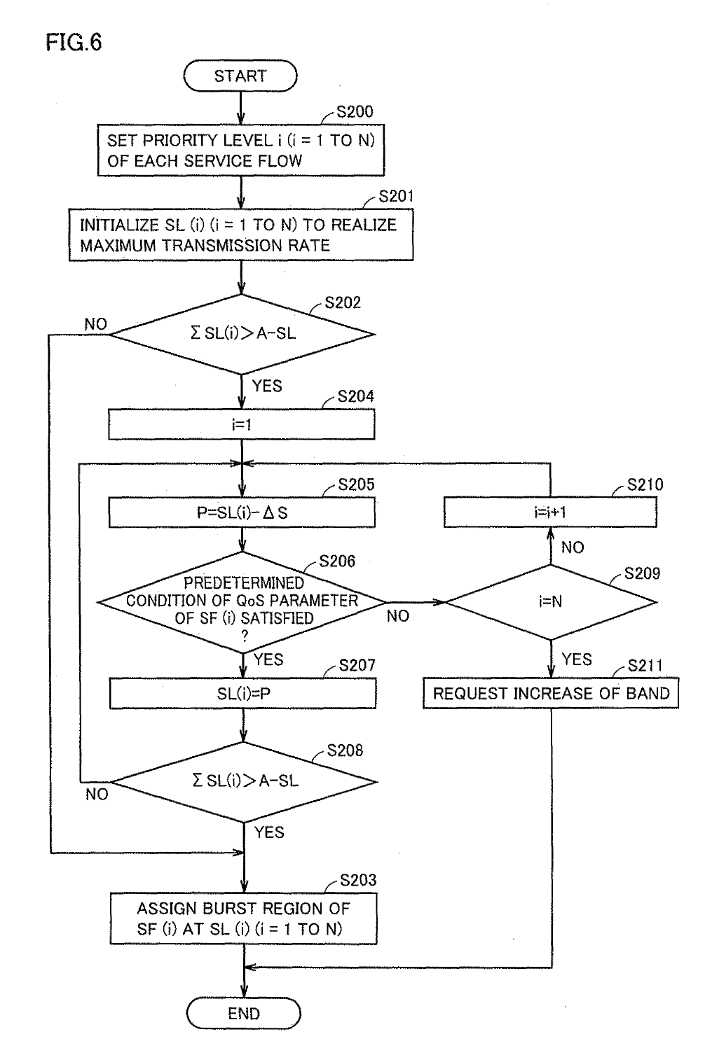

FIG. 6 is a flowchart representing an assignment procedure of a burst region of a service flow by a wireless terminal 4 according to the second embodiment of the present invention. FIG. 6 represents the procedure when the burst region of all service flows is to be newly assigned.

Referring to FIG. 6, service flow assignment unit 10 sets the service flow priority level i for N service flows. It is assumed that priority level i=N corresponds to the highest priority, whereas priority level i=1 corresponds to the lowest priority. The priority level setting may be determined in advance for each service flow, or have FTP, for example, set as the highest priority. Alternatively, the user of wireless terminal 4 may set the priority level for each service flow through the input unit (key or touch panel) of wireless terminal 4 (step S200).

Then, service flow assignment unit 10 initializes the number of slots SL (i) for a service flow SF (i) of priority level i such that the maximum transmission rate defined in the QoS parameters is realized, for all the generated N service flows (step S201).

Then, service flow assignment unit 10 determines whether the total number of slots SL (i) of the N service flows exceeds a slot count ASL of the user data burst region assigned to its own terminal (step S202).

When the total number of slots SL (i) of the N service flows is less than or equal to the slot count A_SE of the user data burst region (NO at step S202), service flow assignment unit 10 assigns, for each service flow SF (i), a burst region of a size corresponding to the set number of slots SL (i) out of the user data burst region assigned to its own terminal (step S203).

When the total number of slots SL (i) of the N service flows exceeds the slot count A_SL of the user data burst region (YES at step S202), service flow assignment unit 10 reduces the number of slots to be assigned in the following manner.

First, service flow assignment unit 10 sets the priority level i to 1 that is the lowest value representing the lowest priority level (step S204).

Then, service flow assignment unit 10 calculates a value P that is the number of slots SL (i) of service flow SF (i) minus ΔS (a predetermined fixed value) (step S205).

Service flow assignment unit 10 identifies whether the conditions defined for the maximum transmission rate (for all service types), the minimum transmission rate (for rtPS, ertPS, and nrtPS), the maximum delay time (for UGS, rtPS, and ertPS), and the tolerable jitter (delay time variation) (UGS) among the QoS parameters for service flow SF (i) are satisfied, when the number of slots of service flow SF (i) is P (step S206).

When the aforementioned conditions defined in the QoS parameters are satisfied (YES at step S206), service flow assignment unit 10 set the number of slots SL (i) of service flow SF (i) at P (step S207).

Then, service flow assignment unit 10 determines whether the total number of slots SL (i) of the N service flows exceeds slot count A_SL of the user data burst region assigned to its own terminal (step S208).

When the total number of slots SL (i) of the N service flows is less than or equal to slot count A_SL of the user data burst region (NO at step S208), service flow assignment unit 10 assigns, for each service flow SF (i), a burst region of a size corresponding to the set number of slots SL (i) out of the user data burst region assigned to its own terminal (step S203).

When the total number of slots SL (i) of the N service flows exceeds slot count A_SL of the user data burst region (YES at step S208), service flow assignment unit 10 returns to step 5205 to carry out the process of reducing the number of slots of service flow SF (i).

When NO at step 5206, i.e. the conditions defined in the QoS parameters are not satisfied, and when the priority level i is not N (NO at step 5209), service flow assignment unit 10 increments priority level i by just 1 (step S210), and returns to step S205. When the priority level i is N (YES at step S209), service flow assignment unit 10 determines that assignment of a service flow that satisfies the conditions defined in the QoS parameters is not possible with the current assigned user data burst region, and requests wireless base station 3 of an increase of the band via transmission and reception unit 7 (step S211).

Thus, according to the second embodiment of the present invention, the data of a service flow having a higher priority level selected by the user through the input unit (key or touch panel), or a higher priority level determined in advance can be transmitted at a transmission rate as high as possible according to a scheme differing from that of the first embodiment.

### Third Embodiment

The third embodiment relates to a wireless terminal assigning a burst region for a service flow according to a scheme differing from those of the first and second embodiments.

(Assignment Operation of Service Flow)

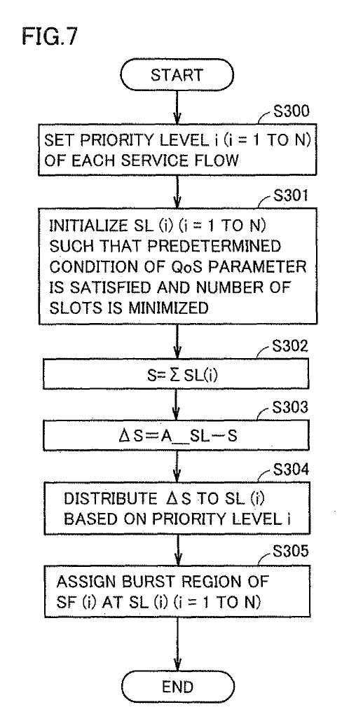

FIG. 7 is a flowchart representing an assignment procedure of a burst region of a service flow by wireless terminal 4 according to a third embodiment of the present invention. FIG. 7 represents the procedure when the burst region of all service flows is to be newly assigned.

Referring to FIG. 7, service flow assignment unit 10 sets the service flow priority level i for N service flows. It is assumed that priority level i=N corresponds to the highest priority, whereas priority level i=1 corresponds to the lowest priority. The priority level setting may be determined in advance for each service flow, or have FTP, for example, set as the highest priority. Alternatively, the user of wireless terminal 4 may set the priority level for each service flow through the input unit (key or touch panel) of wireless terminal 4 (step S300).

Then, service flow assignment unit 10 initializes the number of slots SL (i) of service flow SF (i) of priority level i. Specifically, service flow assignment unit 10 sets the number of slots SL (i) such that the conditions defined for the maximum transmission rate (for all service types), the minimum transmission rate (for rtPS, ertPS, and nrtPS), the maximum delay time (for UGS, rtPS, and ertPS), and the tolerable jitter (delay time variation) (UGS) among the QoS parameters for service flow SF (i) are satisfied and such that the number of slots is minimum (step S301).

Service flow assignment unit 10 calculates the total S of the number of slots SL (i) of the N service flows SF (i) (step S302).

Service flow assignment unit 10 calculates a value AS that is the slot count A_SL of the assigned user data burst region minus the total S of the number of slots SL (i) (step S303).

Service flow assignment unit 10 distributes AS to the number of slots SL (i) of service flow SF (i) based on priority level i. For example, service flow assignment unit 10 increases the number of slots SL (i) of service flow SF (i) by just ΔS×i/{N (N+1)/2} (step S304).

Then, service flow assignment unit 10 assigns a burst region of a size corresponding to the set number of slots SL (i) out of the user data burst region assigned to its own terminal (step S305).

Thus, according to the third embodiment of the present invention, the data of a service flow having a higher priority level selected by the user through the input unit (key or touch panel), or a higher priority level determined in advance can be transmitted at a transmission rate as high as possible according to a scheme differing from that of the first and second embodiments.

### Fourth Embodiment

The fourth embodiment relates to a wireless terminal assigning a burst region for a service flow according to a scheme differing from those of the first to third embodiments.

(Assignment Operation of Service Flow)

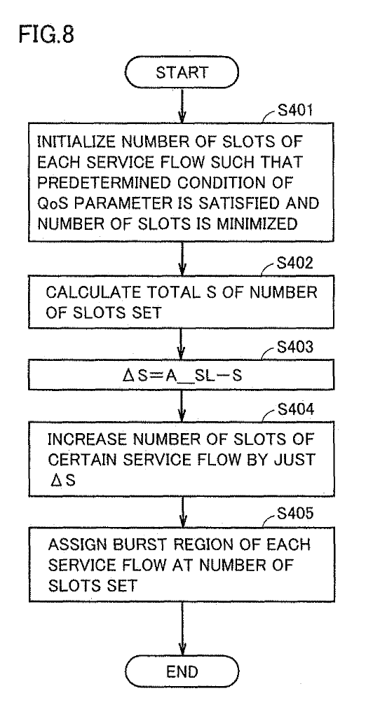

FIG. 8 is a flowchart representing an assignment procedure of a burst region of a service flow by wireless terminal 4 according to a fourth embodiment of the present invention. FIG. 8 represents the procedure when the burst region of all service flows is to be newly assigned.

Referring to FIG. 8, service flow assignment unit 10 initializes the number of slots of each service flow. As used herein, a slot is a unit constituted of a plurality of subcarriers on the frequency axis in an OFDMA frame and a plurality of continuous symbols on the time axis. Specifically, service flow assignment unit 10 initializes the number of slots such that the conditions defined for the maximum transmission rate (for all service types), the minimum transmission rate (for rtPS, ertPS, and nrtPS), the maximum delay time (for UGS, rtPS, and ertPS), and the tolerable jitter (delay time variation) (UGS) among the QoS parameters for each service flow are satisfied and the number of slots is minimum (step S401).

Then, service flow assignment unit 10 calculates the total S of the number of slots of the N service flows SF (i) (step S402).

Service flow assignment unit 10 calculates a value AS that is the slot count A_SL of the assigned user data burst region minus the total S of the number of slots (step S403).

Then, service flow assignment unit 10 increases the number of slots of a certain service flow by just ΔS. The certain service flow may be determined in advance, or be the service flow of FTP, for example. Alternatively, the certain service flow may be selected by the user of wireless terminal 4 through the input unit (key or touch panel) of wireless terminal 4 (step S404).

Then, service flow assignment unit 10 assigns a burst region of a size corresponding to the set number of slots SL, out of the user data burst region assigned to its own terminal (step S405).

Thus, according to the fourth embodiment of the present invention, the data of a service flow having a higher priority level selected by the user through the input unit (key or touch panel), or a higher priority level determined in advance can be transmitted at a transmission rate as high as possible according to a scheme differing from that of the first to third embodiments.

(Modification)

The present invention is not limited to the above-described embodiments, and may include modifications set forth below.

(1) Condition of QoS Parameters

The embodiments of the present invention are based on, but not limited to assigning a burst region for a certain service flow, prioritized over other service flows, upon satisfying conditions of QoS parameters. In the case where the conditions of QoS parameters do not necessarily have to be satisfied in a wireless communication system other than WiMAX, the QoS may be ignored.

(2) Assignment of Service Flow Region

In the first embodiment of the present invention, a burst region is assigned prioritizing only one service flow over other service flows. In the second embodiment of the present invention, all service flows are given a priority level, and a burst region is assigned, prioritizing the service flow that has a higher priority level. Assignment of a service flow region is not limited to such configurations.

For example, a burst region may be assigned, prioritizing M (N>M) service flows, among N service flows, over the remaining (N−M) service flows.

Furthermore, the burst region of a service flow of high priority level is not limited to that realizing the maximum transmission rate. The burst region may be set such that the transmission rate is higher than that of a burst region of a service flow having a lower priority level.

It is to be understood that the embodiments disclosed herein are only by way of example in all respect, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

1 wireless communication system; 2 management server; 3 wireless base station; 4a-4n, 4 wireless terminal; 5, 6 antenna; 7 transmission and reception unit; 8 control unit; 9 burst region management unit; 10 service flow assignment unit; 11 QoS management unit.

1. A wireless terminal comprising:
a QoS management unit receiving notification of QoS parameters for a plurality of uplink service flows from a wireless base station,
a burst region management unit receiving notification of an uplink user data burst region from said wireless base station, and
a service flow assignment unit assigning a region of uplink service flows at the uplink user data burst region assigned to its own terminal,
said service flow assignment unit assigning a region of said plurality of uplink service flows, prioritizing a region of at least one service flow satisfying conditions of a transmission rate, delay time, and delay time variation in the notified QoS parameters for each uplink service flow over a region of another service flow.

2. The wireless terminal according to claim 1, wherein said service flow assignment unit assigns a region of a service flow specified by a user, giving priority over the region of another service flow.

3. The wireless terminal according to claim 1, wherein said service flow assignment unit assigns a region of a predetermined service flow, giving priority over the region of another service flow.

4. The wireless terminal according to claim 3, wherein said predetermined service flow is FTP.

5. A wireless communication method comprising the steps of:
receiving notification of QoS parameters for a plurality of uplink service flows from a wireless base station,
receiving notification of an uplink user data burst region from said wireless base station, and
assigning a region of uplink service flows at the uplink user data burst region assigned to its own terminal,
said assigning step including the step of assigning a region of said uplink service flows, prioritizing a region of at least one service flow satisfying conditions of a transmission rate, delay time, and delay time variation in the notified QoS parameters of each uplink service flow over a region of another service flow.
